(19) United States
(12) Patent Application Publication
(10) Pub. No.: US 2024/0169182 A1
(43) Pub. Date: May 23, 2024

(54) APPARATUS AND METHOD FOR GENERATING AN ACTIVITY ARTICLE

(71) Applicant: Lede AI, Mansfield, OH (US)

(72) Inventors: Carl Fernyak, Lucas, OH (US); Curt Conrad, Mansfield, OH (US); Evan Ryan, Lucas, OH (US); Jay Allred, Mansfield, OH (US); Larry Phillips, Mansfield, OH (US)

(73) Assignee: Lede AI, Mansfield, OH (US)

(21) Appl. No.: 17/993,108

(22) Filed: Nov. 23, 2022

(51) Int. Cl. G06N 3/045; G06N 20/20

(52) U.S. Cl. CPC G06N 3/045; G06N 20/20

(57) ABSTRACT

An apparatus for generating an activity article, the apparatus includes at least a processor and a memory, wherein the memory contains instructions configuring the at least a processor to receive activity data from an activity data source, determine an activity classification as a function of the activity data, select a plurality of tokens as a function of the activity classification, and generate an activity article as a function of the plurality of tokens, wherein the activity article containing contains an activity article link.

### FIELD OF THE INVENTION

The present invention generally relates to the field of article generation. In particular, the present invention is directed to an apparatus and method for generating an activity article.

### BACKGROUND

Articles are time consuming and sometimes difficult for journalists to write. In some cases, the cost of having a journalist write an article on a sporting event or other activity, may outweigh the benefits. Furthermore, it may be difficult for readers to make connections between relevant articles. A solution for automatically generating easy to read and reliable articles is needed. Existing solutions are not satisfactory.

### SUMMARY OF THE DISCLOSURE

In an aspect, an apparatus for generating an activity article, the apparatus includes at least a processor and a memory communicatively connected to the at least a processor, wherein the memory contains instructions configuring the at least a processor to receive activity data from an activity data source, determine an activity classification as a function of the activity data, select a plurality of tokens as a function of the activity classification, and generate an activity article as a function of the plurality of tokens, wherein the activity article containing an activity article link.

In another aspect A method for generating an activity article, the method includes receiving, by at least a processor, activity data from an activity data source, determining, by the at least a processor, an activity classification as a function of the activity data, selecting, by the at least a processor, a plurality of tokens as a function of the activity classification, and generating, by the at least a processor, an activity article as a function of the plurality of tokens, wherein the activity article containing an activity article link.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for generating an activity article;

FIG. 2 is a block diagram of an exemplary machine-learning process;

FIG. 3 is a diagram of an exemplary embodiment of neural network;

FIG. 4 is a diagram of an exemplary embodiment of a node of a neural network;

FIG. 5 is a schematic diagram illustrating an exemplary embodiment of a fuzzy inferencing system;

FIG. 6 is a block diagram of an exemplary embodiment of activity data;

FIG. 7 is a flow diagram of an exemplary method for generating an activity article; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus and methods for generating an activity article, the apparatus includes at least a processor and a memory communicatively connected to the at least a processor, wherein the memory contains instructions configuring the at least a processor to receive activity data from activity data source, determine an activity classification as a function of the activity data, select a plurality of tokens as a function of the activity classification, and generate an activity article as a function of the plurality of tokens, wherein the activity article optionally containing an activity article link and boilerplate data. Exemplary embodiments illustrating aspects of the present disclosure are described below in the context of several specific examples.

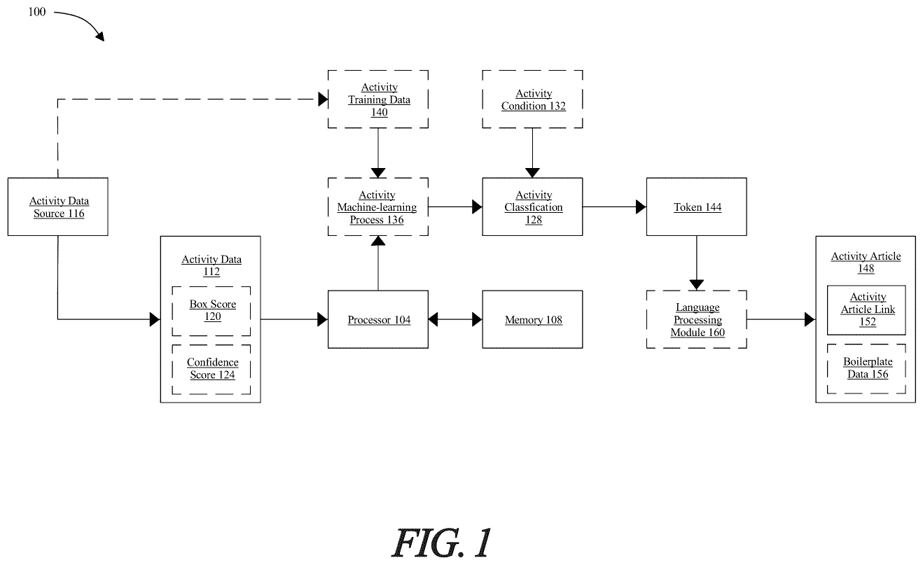

Referring now to FIG. 1, an exemplary embodiment of an apparatus 100 for generating an activity article is illustrated. Apparatus includes a processor 104 and a memory 108 communicatively connected to the processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, as used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, apparatus and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 104 is configured to receive activity data 112 from activity data source 116. As used in this disclosure, “receive” means accepting, collecting, or otherwise receiving input from activity data source 116 described in further detail below. As used in this disclosure, an “activity data” is data concerning an activity. As used in this disclosure, an “activity” is a scored event that one or more people may partake in. In a non-limiting example, activity data may include data regarding to a sporting event. In some cases, sporting event may include, without limitation, American football, soccer, volleyball, baseball, softball, cricket, darts, bowling, and the like thereof. In another non-limiting example, activity data may include data regarding to a gaming event. In some cases, gaming event may include, chess, darts, cards, multiplayer video games, and the like thereof. In a non-limiting example, activity data 112 may include, without limitation, game details, team information, player information, time duration, and the like thereof. In another non-limiting example, activity data 112 may include a minute-by-minute sporting event commentary script. In some embodiments, activity data 112 may include a box score 120. As used in this disclosure, a “box score” is a structured summary of results from a sporting event or activity. In some embodiments, box score 120 may break the activity data 112 into temporal divisions of the sporting event, such as, without limitation, quarters, halves, periods, frames, innings, sets, and the like thereof. In a non-limiting example, a box score 120 may include a data element similar to “Team A x: Team B y,” wherein the data element may compare team A score x to team B score y. In some embodiments, the score may be the points scored by the end of a temporal division. In some embodiments, the score may be the points scored during a temporal division. In some embodiments, box score 120 may include a list of events. List of events may include, for example, a list of the scoring events or other significant events, such as penalties, injuries, turnovers, and the like.

With continued reference to FIG. 1, in some embodiments, activity data 112 may further includes a confidence score 124. As used in this disclosure, a “confidence score” is a quantitative measurement of the accuracy of the data such as, without limitation, activity data 112. Confidence score 124 may be on a scale of x to y, wherein x may represent a minimum confidence score and y may represent a maximum confidence score; for instance, confidence score 124 may be on a scale of 0 to 100, wherein a confidence score close to 0 may be a low confidence score, and a confidence score close to 100 may be a high confidence score. Low confidence score may indicate activity data 112 is less reliable, while high confidence score may indicate activity data 112 is more reliable. In some embodiments, activity data 112 may include a plurality of confidence scores 124, wherein each confidence score of plurality of confidence scores 124 may associate with a single box score 120. An overall confidence score may be calculated, generated, or determined as a function of plurality of confidence scores 124. Additionally, or alternatively, confidence score 124 may be a user-defined score. In a non-limiting example, a user may review activity data 112 and determine one or more confidence score 124 based on the user's intuition. In other embodiments, confidence score 124 may be obtained from or received along with activity data 112 from activity data source described in further detail below.

With continued reference to FIG. 1, in some embodiments, activity data 112 and/or any data/information described in this disclosure may be present as a vector. As used in this disclosure, a “vector” is a data structure that represents one or more quantitative values and/or measures of home resource data. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent, for instance as measured using cosine similarity as computed using a dot product of two vectors; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes.

With continued reference to FIG. 1, in some embodiments, activity data 112 and/or any other data/information described in this disclosure may be present as a dictionary. As used in this disclosure, a “dictionary” is a data structure containing an unordered set of key value pairs. In this disclosure, a “key value pair” is a data representation of a data element such as, without limitation, entries of box score 120, confidence score 124, any other information within activity data 112, and the like thereof. In some cases, dictionary may be an associative memory, or associative arrays, or the like thereof. In a non-limiting example, dictionary may be a hash table. In an embodiment, kay value pair may include a unique key, wherein the unique kay may associate with one or more values. In another embodiment, key value pair may include a value, wherein the value may associate with a single key. In some cases, each key value pair of set of key value pairs in dictionary may be separated by a separator, wherein the separator is an element for separating two key value pairs. In a non-limiting example, separator may be a comma in between each key value pairs of plurality of key value pairs within dictionary. In another non-limiting example, a dictionary may be expressed as “{first key value pair, second key value pair},” wherein the first key value pair and the second key value pair may be separate by a comma separator, and wherein both first key value pair and second key value pair may be expressed as “first/second key: first/second value.” In a further non-limiting example, activity data 112 may be present as a dictionary: “{x: A, y: B},” wherein x may be a first entry correspond to a box score A and y may be a second entry correspond to a confidence score B. Additionallay, or alternatively, dictionary may include a term index, wherein the term index is a data structure to facilitate fast lookup of entries within dictionary (i.e., index). In some cases, without limitation, term index may use a zero-based indexing, wherein the zero-based indexing may configure dictionary to start with index 0. In some cases, without limitation, term index may use a one-based indexing, wherein the one-based indexing may configure dictionary to start with index 1. In other cases, without limitation, term index may use a n-based indexing, wherein the n-based indexing may configure dictionary to start with any index from 0 to n. Further, term index may be determined/calculated using one or more hash functions. As used in this disclosure, a “hash function” is a function used to map a data of arbitrary size to a fixed-size value. In some cases, a fixed-size value may include, but is not limited to, hash value, hash code, hash digest, and the like. In a non-limiting example, activity data 112 may be present as a dictionary containing a plurality of hashes generated using hash function such as, without limitation, identity hash function, trivial hash function, division hash function, word length folding, and the like, wherein each hash of plurality of hashes may represents a single box score 120.

With continued reference to FIG. 1, in other embodiments, activity data 112 and/or any other data/information described in this disclosure may be present as any other data structure such as, without limitation, tuple, single dimension array, multi-dimension array, list, linked list, queue, set, stack, dequeue, stream, map, graph, tree, and the like thereof. In some embodiments, activity data 112 and/or any other data/information described in this disclosure may be present as a combination of more than one above data structures. In a non-limiting example, activity data 112 may include a dictionary of lists. As will be appreciated by persons having ordinary skill in the art, after having read the entirety of this disclosure, the foregoing list is provided by way of example and other data structures can be added as an extension or improvements of apparatus 100 disclosed herein. In some embodiments, without limitation, data structure may include an immutable data structure, wherein the immutable data structure is a data structure that cannot be changed, modified, and/or updated once data structure is initialized. In other embodiments, without limitation, data structure may include a mutable data structure, wherein the mutable data structure is a data collection that can be changed, modified, and/or updated once data structure is initialized. Additionally, or alternatively, activity data 112 and/or any other data/information described in this disclosure may include an electric file format such as, without limitation, txt file, JSON file, XML file, word document, pdf file, excel sheet, image, video, audio, and the like thereof.

With continued reference to FIG. 1, in some cases, data within data structure described above may be sorted in a certain order such as, without limitation, ascending order, descending order, and the like thereof. In a non-limiting example, sorting data within activity data 112 may include using a sorting algorithm. In some cases, sorting algorithm may include, but is not limited to, selection sort, bubble sort, insertion sort, merge sort, quick sort, heap sort, radix sort, and the like thereof. As will be appreciated by persons having ordinary skill in the art, after having read the entirety of this disclosure, the foregoing list is provided by way of example and other sorting algorithm can be added as an extension or improvements of apparatus 100 disclosed herein.

With continued reference to FIG. 1, as used in this disclosure, an “activity data source” is a source of activity data 112. In some embodiments, without limitation, activity data source 116 may include one or more users. In some cases, users may include a game player, activity organizer, application user, any individual who uses apparatus 100, and the like. In a non-limiting example, box score 120 within activity data 112 of a sporting event may be manually updated by people attending the sporting event. Additionally, or alternatively, activity data 112 may include one or more article configurations, wherein one or more article configurations are parameter used to generate activity article 148 described in further detail below. In some embodiments, receiving activity data 112 may include receiving activity data 112 from the user. In a non-limiting example, user may input a plurality of activity data 112 containing one or more article configurations such as, without limitation, number of authors, coverage area, confidence score 124, dynamic degree, and the like to processor 104 and/or language processing module 160 described in further detail below.

With continued reference to FIG. 1, in some embodiments, activity data source 116 may include a data store such as, without limitation, a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In a non-limiting example, a scheduler may store activity data 112 at a specified time after event ends in database. Processor 104 may be configured to access database and/or retrieve activity data 112 within database through one or more database queries. In other embodiments, activity data source 116 may include one or more application program interface (API), wherein the application programming interface is a way for two or more devices and or programs to communicate with each other. In a non-limiting example, processor 104 within apparatus 100 may be configured to fetch activity data 112 through sport data feed application programming interface at a specific endpoint.

With continued reference to FIG. 1, processor 104 is further configured to determine an activity classification 128 as a function of activity data 112. As used in this disclosure, an “activity classification” is a type of an activity. The activity may include, without limitation, sporting events described above. In a non-limiting example, activity classification 128 may include “blowout victory,” “come-from-behind win,” “huge loss,” “close game,” “overtime thriller,” and/or the like. In some embodiments, determining activity classification 128 may include applying a plurality of activity conditions 132 to activity data 112. As used in this disclosure an “activity condition” is a circumstance affecting the activity. In a non-limiting example, activity condition 132 may include one or more circumstance that affect a sporting event to fall into one or more categories such as, without limitation, activity classification 128 described above. In some embodiments, activity condition 132 may use activity data 112 that is broken into temporal divisions, such as box score 120, to determine activity classification 128. In a non-limiting example, processor 104 may receive activity data 112 of a football game. Activity data 112 may include one or more box scores 120 that matches with an activity condition 132, wherein the activity condition 132 may include “(a team) lead after every quarter and won by a certain margin.” In this circumstance, for example, activity data 112 may then be classified as a “blowout victory.” In another non-limiting example, activity data 112 regarding to a football game may include one or more box scores 120 that matches with an activity condition 132, wherein the activity condition 132 may include “(a team) was trailing after halftime but won the game.” Activity data 112 may then be determined as a “come-from-behind win.” In some embodiments, determining activity classification 128 may include applying a first set of activity conditions to activity data 112 and applying a second set of activity conditions to activity data, wherein the first set of activity conditions is a subset of the second set of activity conditions. In a non-limiting example, processor 104 may apply plurality of activity conditions 132 to activity data 112 from most restrictive circumstances to least restrictive circumstances; for instance, processor 104 may first check whether there is a match with circumstances of “overtime game.” Processor 104 may then check whether there is a match with circumstances of “comeback win.” Processor 104 may finally check whether there is a match with circumstances of “normal game.”

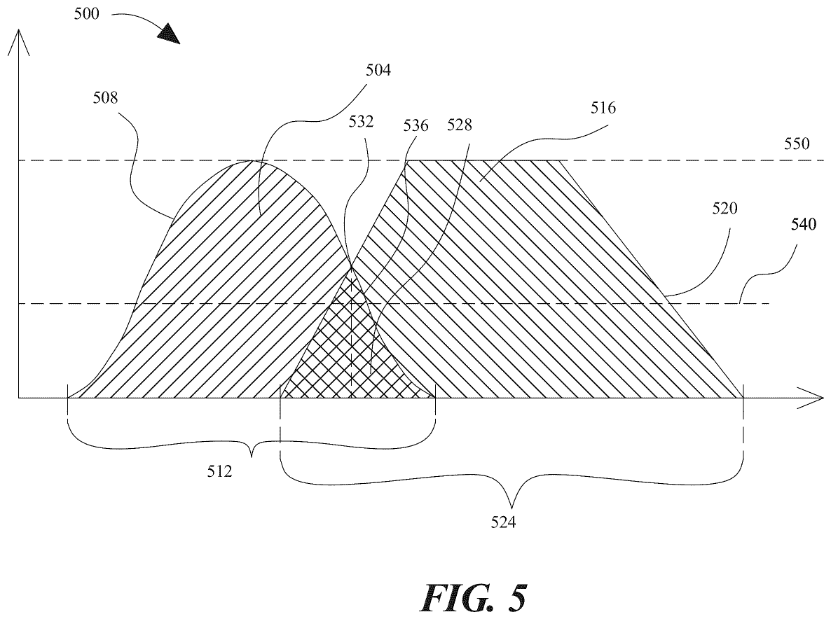

With continued reference to FIG. 1, in some embodiments, determining activity classification 128 may include a use of a rule-based engine. As used in this disclosure, a “rule-based engine” is a system that executes one or more rules in a runtime production environment. As used in this disclosure, a “rule” is a pair including a set of conditions and a set of actions, wherein each condition within the set of conditions is a representation of a fact, an antecedent, or otherwise a pattern, and each action within the set of actions is a representation of a consequent. In a non-limiting example, rule may include a condition such as, without limitation, activity condition 132 of “(a team) did not score for the whole game” pair with a consequent such as, without limitation, activity classification 128 of “huge loss.” In some embodiments, rule-based engine may execute one or more rules on activity data 112 if any activity conditions 132 are met. In some embodiments, rule-based engine may include an inference engine for determine a match of activity condition 132, where any or all activity data 112 may be represented as values and/or fuzzy sets for linguistic variables measuring the same, as described in more detail in FIG. 5. Inference engine may use one or more fuzzy inferencing rules to output one or more linguistic variable values and/or defuzzified values indicating match of activity condition 132. As used in the current disclosure, a “fuzzy inference” is a method that interprets the values in the input vector (i.e., activity data 112, activity classification 128.) and, based on a set of rules, assigns values to the output vector. A fuzzy set may also be used to show degree of match between fuzzy sets may be used to rank one resource against another. For instance, if both excessive activity data 112 and activity classification 128 have fuzzy sets, activity classification 128 may be determined by having a degree of overlap exceeding a predetermined threshold.

With continued reference to FIG. 1, processor 104 may determine activity classification 128 using a using a lookup table. A “lookup table,” for the purposes of this disclosure, is an array of data that maps input values to output values. A lookup table may be used to replace a runtime computation with an array indexing operation. In another non limiting example, an activity classification lookup table may be able to correlate activity data 112 to an activity condition 132, and further correlate the activity condition 132 to an activity classification 128. Processor 104 may be configured to “lookup” activity data 112 and/or activity condition 132 in order to find a corresponding activity condition 132 and/or activity classification 128.

With continued reference to FIG, 1, in some embodiments, determining activity classification 128 may include training an activity machine-learning process 136. A “machine-learning process,” as used in this disclosure, is a process that automatedly uses a body of data known as training data and/or a training set (described further below in this disclosure) to generate an algorithm that will be performed by processor 104 to produce outputs given data provided as inputs; this is in contrast to a non-machine learning software program where the commands to be executed are determined in advance by a user and written in a programming language. Activity machine-learning process 136 may utilize supervised, unsupervised, lazy-learning processes and/or neural networks, described further below. Activity machine-learning process 136 may be trained using activity training data 140, wherein the activity training data 140 may include a plurality of activity data 112 as input correlated to a plurality of activity classifications 128. In an embodiment, activity training data 140 may be obtained from activity data source 116 described above. In another embodiments, activity training data 140 may include manually labeled data. As a non-limiting example, activity data 112 may be manually collected and labeled by the user and/or a professional such as, without limitation, player, activity organizer, anyone who participant in the activity, and the like thereof. Processor 104 may then determine activity classification 128 as a function of trained activity machine-learning process 136. In some embodiments, activity machine-learning process 136 may be used to determine activity classification 128 based on input containing activity data 112; this may be performed using, without limitation, through classification. In some cases, classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, as used in this disclosure, a “classifier” is a machine-learning model, such as a mathematical model, neural net, or program generated by a machine learning algorithm known as a “classification algorithm,” as described in further detail below, that sort inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Processor 104 and/or another device may generate a classifier using a classification algorithm, defined as a process whereby a processor 104 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, in some embodiments, processor 104 may be configured to generate machine learning model such as, without limitation, activity machine-learning process 136, using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A)P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, in some embodiments, processor 104 may be configured to generate machine learning model such as, without limitation, activity machine-learning process 136, using a K-nearest neighbors (KNN) algorithm. A “K-nearest neighbors algorithm” as used in this disclosure, includes a classification method that utilizes feature similarity to analyze how closely out-of-sample- features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm, where aᵢ is attribute number experience of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With continued reference to FIG. 1, processor 104 is further configured to select a plurality of tokens 144 as a function of the activity classification 128. As used in this disclosure, a “token” is a linguistic segment. In a non-limiting example, tokens 144 may include words, phrases, sentences, and the like. In some cases, tokens 144 may be tagged to correspond with different activity classifications 128. In other cases, tokens may be tagged to correspond with multiple activity classifications 128. In a non-limiting example, plurality of tokens 144 may include a first token correspond to a first activity classification and a second token corresponds to a second activity classification. For instance, first token “got out to an early lead” may correspond to first activity classification “blowout victory.” Second token “follow closely behind” may correspond to second activity classification “close game.” More exciting adjectives and adverbs may be tagged with more exciting activity classifications 128. In some embodiments, selecting plurality of tokens 144 may include selecting one or more tokens corresponding to determined activity classification 128 described above. Additionally, or alternatively, plurality of tokens 144 may be stored and/or retrieved from database described above in reference to activity data source 116. In a non-limiting example, selecting plurality of tokens 144 may include selecting plurality of tokens from a bank of content, wherein the bank of content may include a plurality of linguistic data. Bank of content may be stored in a database as described above.

With continued reference to FIG. 1, processor 104 is further configured to generate an activity article 148 as a function of plurality of tokens 144. As used in this disclosure, an “activity article” is a piece of writing about an activity. For example an activity may include, without limitation, a sporting event described above. In some cases, activity article may be in a newspaper, magazine, any other publications, and the like thereof. In some embodiments, generating activity article 148 may include comparing confidence score 124 to a confidence threshold and generating activity article 148 as a function of the comparison of confidence score 124 and the confidence threshold. As used in this disclosure, a “confidence threshold” is a confidence score magnitude that must be exceeded for certain condition to occur or be manifested. In a non-limiting example, activity article 148 may be generated by processor 104 if, and only if confidence score 124 of activity data 112 exceeds confidence threshold. In another non-limiting example, activity article 148 may not be generated by processor 104 if confidence score 124 is missing or is below a confidence threshold.

With continued reference to FIG. 1, in some embodiments, generating activity article 148 may include arranging plurality of tokens 144 as a function of activity classification 128 In some embodiments, arranging plurality of tokens 144 may include placing plurality of tokens 144 into activity article 148. In a non-limiting example, processor 104 may be configured to generate an activity article 148 of an activity according to an activity classification 128 of the activity. For example, activity article 148 may include “x, y, z.” Plurality of tokens may include a first set of tokens, a second set of tokens, and a third set of tokens, wherein the first set of tokens may include tokens describe the beginning of activity, wherein the second set of tokens may include tokens describe the activity in progress, and wherein the third set of tokens may include tokens describe the end of activity. Processor 104 may then replace x in activity article 148 with first set of tokens, y with second set of tokens, and z with third set of tokens. In another non-limiting example, processor 104 may be configured to generate an activity article 148 of a sporting event with an activity classification 128: “overtime thriller.” Generating activity article 148 may first start by selecting a first set of tokens from plurality of tokens 144 and placing the first set of tokens at beginning of activity article 148, wherein first set of tokens may include tokens describe the overtime portion of the sporting event. Processor 104 may then select a second set of tokens from plurality of tokens 144 and place the second set of tokens after first set of tokens, wherein second set of tokens may include tokens describe beginning to end of the game. In other non-limiting example, processor 104 may be configured to generate an activity article 148 of a sporting event with an activity classification 128: “blowout victory.” Generating activity article 148 may include arranging one or more set of tokens selected from plurality of tokens 144 chronologically; for instance, arranging one or more set of tokens from first portion of sporting event to last portion of sporting event.

Within continued reference to FIG. 1, activity article 148 may includes an activity article link 152 and/or boilerplate data 156. As used in this disclosure, an “activity article link” is an element within activity article 148 that contains a relationship between activity article 148 and one or more other objects. In some embodiments, activity article link 152 may include a hyperlink. As used in this disclosure, a “hyperlink” is a digital reference to data such as, without limitation, activity article 148. In some cases, hyperlink may be interaction component described in further detail below. In some embodiments, generating activity article 148 may include generating an activity article link 152, wherein generating the activity link 152 may include tagging activity article with an activity article tag. As used in this disclosure, an “activity article tag” is an identifier used to group and/or identify a group of similar activity articles. In some cases, activity articles may be similar when content such as, without limitation, team, player, activity time, and the like are same. In other cases, activity articles may be similar when activity classifications 128 are identical. Activity article may include a plurality of activity article tags. In a non-limiting example, two activity articles may include contents reporting a same team. Processor 104 may be configured to tag both activity articles with team name as activity article tag. Generating activity article link may further include identifying a previous activity article as a function of activity article tag. As used in this disclosure, a “previous activity article” is an activity article generated and/or published before. Previous activity article may be generated using processing steps described in this disclosure. In some embodiments, previous activity article may include an activity article concerning one or more aspects of a previous activity related to the current activity. In some embodiments, activity article 148 and/or previous activity article may be stored in database described above. In some cases, storing activity article 148 and/or previous activity article may include storing them based on their activity article tag. In a non-limiting example, database may include a first table storing a first collection of activity articles and a second table storing a second collection of activity articles, wherein each activity article of the first collection of activity articles may be tagged with a first activity article tag and each activity article of the second collection of activity articles may be tagged with a second activity article tag, and wherein the first activity article tag is different from the second activity article tag. In some embodiments, previous activity articles may be selected from database containing at least one activity article with at least one identical activity article tag. Generating activity article link 152 may further include generating the activity article link as a function of previous activity article. Generating activity article link 152 may include using any processing step described in this disclosure. In a non-limiting example, generating activity article link 152 may include selecting one or more tokens 144 from previous activity articles and generating activity article link 152 by rearranging tokens 144. In another non-limiting example, generating activity article link 152 may include summarizing previous activity article into a sentence using language processing module described in further detail below. Further, generating activity article 148 may further include inserting generated activity article link 152 into the activity article 148. In a non-limiting example, activity article 148 may include one or more activity article links 152 that link to one or more articles that concerns teams or players' last games, or previous matchups between these teams and/or players. In a non-limiting example, activity article links 152 may be embedded within a plurality of tokens 144 of activity article 148, wherein activity article links 152 may include previous activity articles of the same activity article tag with activity article 148. Inserting activity article link 152 may include inserting activity article link 152 into activity article 148 at different position.

With continued reference to FIG. 1, in some embodiments, activity article link 152 may include an interaction component. As used in this disclosure, an “interaction component” is an element that is interactable. In a non-limiting example, users (i.e., readers) may interact with activity article 148 through interaction component. In some cases, interaction component, may include, without limitation, button, link, image, video, audio, and the like thereof. In some embodiments, interaction component may include an event handler. As used in this disclosure, an “event handler” is an element that operates asynchronously once an event take place. In some cases, event handler may include routine, wherein the routine is a sequence of code that is intended to be called and executed repeatedly when apparatus 100 is running. In a non-limiting example, event handler may include a callback routine, wherein the callback routine may dictate one or more action that follows event. As used in this disclosure, an “event” is an action that take place when the user interacts with apparatus 100, activity article 148, interaction component, and/or any other components/devices that user may interact with. For example, event may include, without limitation, clicking, holding, pressing, tapping, swiping and the like thereof. In some cases, event may include a combination of a plurality of actions. In other cases, event may involve other interactive devices such as, without limitation, mouse, keyboard, display, headphone, any other interactive device that either electrically and/or communicatively connected to apparatus 100, and the like thereof. In some embodiments, event handler may utilize one or more application program interface (API) such as, without limitation, web events and the like thereof. Event handler may operate any processing step described in this disclosure. In a non-limiting example, user may be able to read previous activity article by interact with interaction component within activity article link 152. User may click on interaction component and its corresponding event handler may direct user to previous activity article by open a uniform resource locator (URL) in a new tab of current window containing previous activity article.

With continued reference to FIG. 1, as used in this disclosure, “boilerplate data” is data regarding to standardized text of activity article 148 that can be used repeatedly without making major changes. In some cases, boilerplate data 156 may be selected by the user. In a non-limiting example, boilerplate data 156 may be received from a client. In a non-limiting example, user may be able to customize boilerplate data 156 by editing text within boilerplate data 156. In some embodiments, boilerplate data 156 may include, without limitation, an AI disclaimer, links to a membership service, links to a homepage, and the like thereof. In some cases, boilerplate data 156 may be placed at the end of activity article 148. In a non-limiting example, generating activity article 148 may include inserting a boilerplate data 156 after plurality of tokens 144. In some embodiments, boilerplate data 156 may include a signature of the user (i.e., author or individual who generates activity article 148) and/or a copyright notice or other legal notice.

With continued reference to FIG. 1, in some embodiments, generating the activity article may include generating the activity article using a language processing module 160. Language processing module 160 may include any hardware and/or software module. Language processing module 160 may be configured to extract, from the one or more documents, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. Tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

With continued reference to FIG. 1, language processing module 160 may operate to produce a language processing model. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

With continued reference to FIG. 1, language processing module 160 and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted word, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module 160 may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

With continued reference to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

With continued reference to FIG. 1, language processing module 160 may use a corpus of documents to generate associations between language elements in a language processing module 160, and diagnostic engine may then use such associations to analyze words extracted from one or more documents and determine that the one or more documents indicate significance of a category. In an embodiment, language processing module 160 and/or processor 104 may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into processor 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

With continued reference to FIG. 1, in some embodiments, language processing module 160 may include a grammatical checker. As used in this disclosure, a “grammatical checker” is a component of language processing module that attempts to verify text (i.e., tokens 144) for grammatical correctness. In a non-limiting example, grammatical checker may include a program that runs simultaneously in the background of the runtime environment of language processing module while generating activity article 148. Grammatical checker may automatically correct activity article 148 during, or after activity article 148 generation. Correcting activity article 148 may include, without limitation, grammar, spelling, tense, word choice, and the like thereof.

With continued reference to FIG. 1, additionally, or alternatively, generating activity article 148 may include exporting activity article 148. As used in this disclosure, “exporting” is converting, outputting, or otherwise exporting activity article 148 using processor 104. In some embodiments, exporting activity article 148 may include converting activity article 148 into any data structure described in this disclosure. In some embodiments, exporting activity article 148 may include outputting activity article in a format such as, without limitation, an HTML file, pdf file, text document, word document, and the like thereof. In a non-limiting example, processor 104 may convert text within activity article 148 into one or more HTML tags using a representational state transfer (REST) API, wherein the REST API is an API that conforms to constraints of REST architectural style (i.e., client-server architecture). User (i.e., client) may initiate conversion of activity article 148 by requesting server through REST API. Requesting server may include client sending a request such as, without limitation, a POST request and the like. Server may post converted one or more HTML tags to a customer relationship management (CRM) platform, wherein the CRM platform is a system that administer a business or other organization interactions with users through data analysis. CRM platform may include a back-office system containing a plurality of automated processes that is executable by processor 104. CRM platform may send a unique identifier of exported activity article 148, a HTML file containing one or more converted HTML tags, and a URL to exported activity article 148 through an email. Unique identifier and/or URL to exported activity article 148 may include activity article link 152 described above in this disclosure.

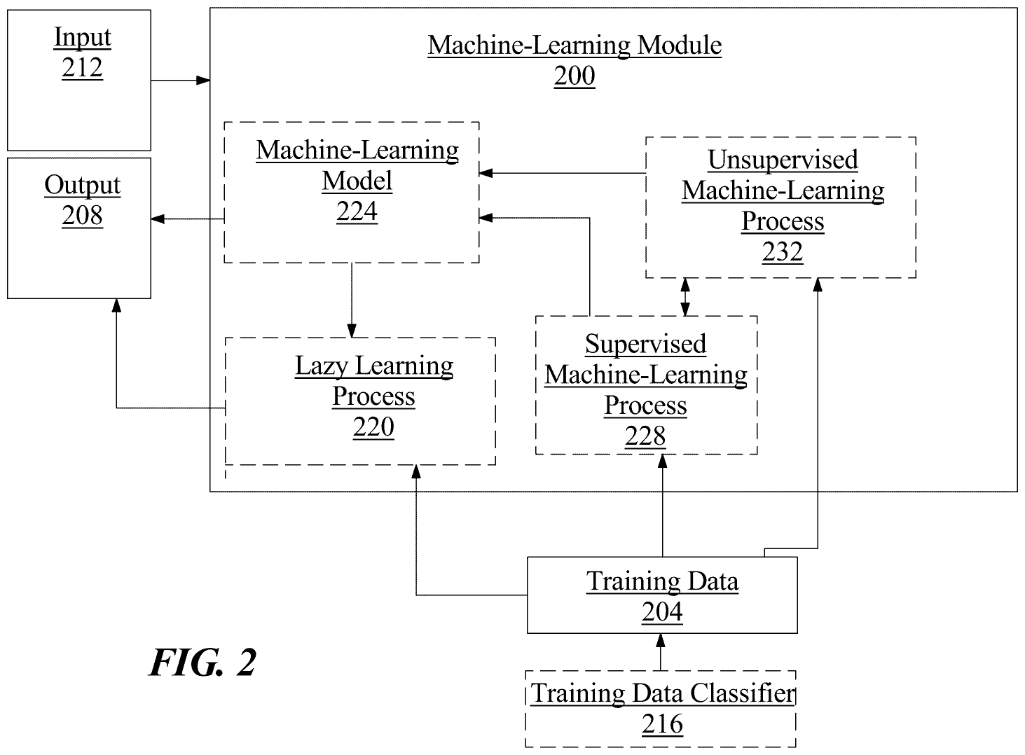

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

With continued reference to FIG. 2, “training data,” as used herein, is data containing correlations that a machine-learning process may use to model relationships between two or more categories of data elements. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 2, alternatively, or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, training data 204 may include a plurality of activity data as input data correlate to a plurality of activity classifications as output data.

With continued reference to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a process whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to activity classifications.

With continued reference to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

With continued reference to FIG. 2, alternatively, or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

With continued reference to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include a plurality of activity data as described above as inputs, a plurality of activity classifications as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With continued reference to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

With continued reference to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

With continued reference to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

With continued reference to FIG. 2, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

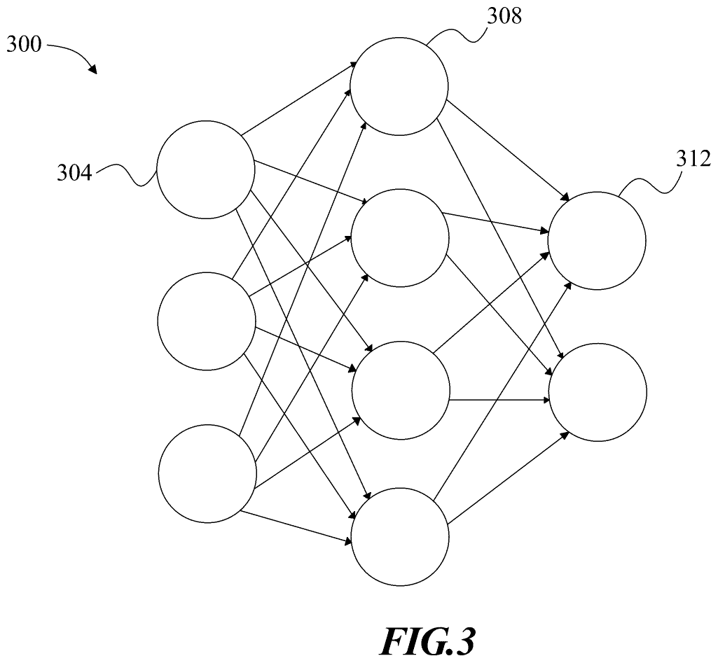

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

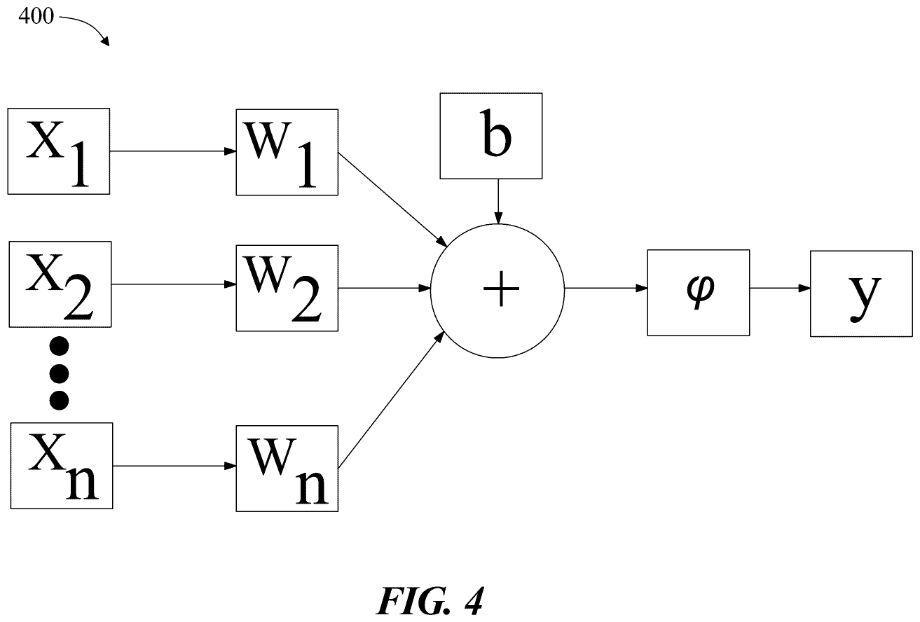

Referring now to FIG. 4, an exemplary embodiment of a node of a neural network is illustrated. A node may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally, or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above.

Referring to FIG. 5, an exemplary embodiment of fuzzy set comparison 500 is illustrated. A first fuzzy set 504 may be represented, without limitation, according to a first membership function 508 representing a probability that an input falling on a first range of values 512 is a member of the first fuzzy set 504, where the first membership function 508 has values on a range of probabilities such as without limitation the interval [0,1], and an area beneath the first membership function 508 may represent a set of values within first fuzzy set 504. Although first range of values 512 is illustrated for clarity in this exemplary depiction as a range on a single number line or axis, first range of values 512 may be defined on two or more dimensions, representing, for instance, a Cartesian product between a plurality of ranges, curves, axes, spaces, dimensions, or the like. First membership function 508 may include any suitable function mapping first range 512 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 5, first fuzzy set 504 may represent any value or combination of values as described above, including output from one or more machine-learning models, activity data, and a predetermined class, such as without limitation of activity classification and the like. A second fuzzy set 516, which may represent any value which may be represented by first fuzzy set 504, may be defined by a second membership function 520 on a second range 524; second range 524 may be identical and/or overlap with first range 512 and/or may be combined with first range via Cartesian product or the like to generate a mapping permitting evaluation overlap of first fuzzy set 504 and second fuzzy set 516. Where first fuzzy set 504 and second fuzzy set 516 have a region 528 that overlaps, first membership function 508 and second membership function 520 may intersect at a point 532 representing a probability, as defined on probability interval, of a match between first fuzzy set 504 and second fuzzy set 516. Alternatively, or additionally, a single value of first and/or second fuzzy set may be located at a locus 536 on first range 512 and/or second range 524, where a probability of membership may be taken by evaluation of first membership function 508 and/or second membership function 520 at that range point. A probability at 528 and/or 532 may be compared to a threshold 540 to determine whether a positive match is indicated. Threshold 540 may, in a non-limiting example, represent a degree of match between first fuzzy set 504 and second fuzzy set 516, and/or single values therein with each other or with either set, which is sufficient for purposes of the matching process; for instance, threshold may indicate a sufficient degree of overlap between an output from one or more machine-learning models and/or activity data and a predetermined class, such as without limitation activity classification categorization, for combination to occur as described above. Alternatively, or additionally, each threshold may be tuned by a machine-learning and/or statistical process, for instance and without limitation as described in further detail below.

Further referring to FIG. 5, in an embodiment, a degree of match between fuzzy sets may be used to classify activity data with activity classification. For instance, if an activity classification has a fuzzy set matching activity data fuzzy set by having a degree of overlap exceeding a threshold, processor 104 may classify the activity data as belonging to the activity classification categorization. Where multiple fuzzy matches are performed, degrees of match for each respective fuzzy set may be computed and aggregated through, for instance, addition, averaging, or the like, to determine an overall degree of match.

Still referring to FIG. 5, in an embodiment, activity data may be compared to multiple activity classification categorization fuzzy sets. For instance, activity data may be represented by a fuzzy set that is compared to each of the multiple activity classification categorization fuzzy sets; and a degree of overlap exceeding a threshold between the activity data fuzzy set and any of the multiple activity classification categorization fuzzy sets may cause processor 104 to classify the activity data as belonging to activity classification categorization. For instance, in one embodiment there may be two activity classification categorization fuzzy sets, representing respectively a first activity classification categorization and a second activity classification categorization. First activity classification categorization may have a first fuzzy set; Second activity classification categorization may have a second fuzzy set; and activity data may have activity data fuzzy set. Processor 104, for example, may compare activity data fuzzy set with each of first activity classification categorization fuzzy set and second activity classification categorization fuzzy set, as described above, and classify an activity data to either, both, or neither of first activity classification categorization nor second activity classification categorization. Machine-learning methods as described throughout may, in a non-limiting example, generate coefficients used in fuzzy set equations as described above, such as without limitation x, c, and σ of a Gaussian set as described above, as outputs of machine-learning methods. Likewise, activity data may be used indirectly to determine a fuzzy set, as activity data fuzzy set may be derived from outputs of one or more machine-learning models that take the activity data directly or indirectly as inputs.

Still referring to FIG. 5, a computing device may use a logic comparison program, such as, but not limited to, a fuzzy logic model to determine an activity classification response. An activity classification response may include, but is not limited to, flat, exciting, gripping, unforgettable and the like; each such activity classification response may be represented as a value for a linguistic variable representing activity classification response or in other words a fuzzy set as described above that corresponds to a degree of match of activity classification as calculated using any statistical, machine-learning, or other method that may occur to a person skilled in the art upon reviewing the entirety of this disclosure. In other words, a given element of activity data may have a first non-zero value for membership in a first linguistic variable value and a second non-zero value for membership in a second linguistic variable value. In some embodiments, determining an activity classification categorization may include using a linear regression model. A linear regression model may include a machine learning model. A linear regression model may be configured to map data of activity data, such as degree of compatibility to one or more activity classification parameters. A linear regression model may be trained using a machine learning process. A linear regression model may map statistics such as, but not limited to, quality of activity data to activity classification. In some embodiments, determining an activity classification of activity data may include using an activity classification model. An activity classification model may be configured to input collected data and cluster data to a centroid based on, but not limited to, frequency of appearance, linguistic indicators of quality, and the like. Centroids may include scores assigned to them such that quality of compatibility of activity data may each be assigned a score. In some embodiments activity classification model may include a K-means clustering model. In some embodiments, activity classification model may include a particle swarm optimization model. In some embodiments, determining the activity classification of activity data may include using a fuzzy inference engine. A fuzzy inference engine may be configured to map one or more activity data elements using fuzzy logic. In some embodiments, activity data may be arranged by a logic comparison program into activity classification arrangement. An “activity classification arrangement” as used in this disclosure is any grouping of objects and/or data based on skill level and/or output score. This step may be implemented as described above in FIGS. 1-4. Membership function coefficients and/or constants as described above may be tuned according to classification and/or clustering algorithms. For instance, and without limitation, a clustering algorithm may determine a Gaussian or other distribution of questions about a centroid corresponding to a given level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 5, an inference engine may be implemented according to input and/or output membership functions and/or linguistic variables. For instance, a first linguistic variable may represent a first measurable value pertaining to activity data, such as a degree of match of activity classification of an element, while a second membership function may indicate a degree of in activity classification of a subject thereof, or another measurable value pertaining to activity data. Continuing the example, an output linguistic variable may represent, without limitation, a score value. An inference engine may combine rules, such as: “if the activity is ‘football” and the score difference is ‘high’, the activity classification is ‘huge win”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively, or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively, or additionally, output rules may be replaced with functions according to the Takagi-Sugeno-King (TSK) fuzzy model.

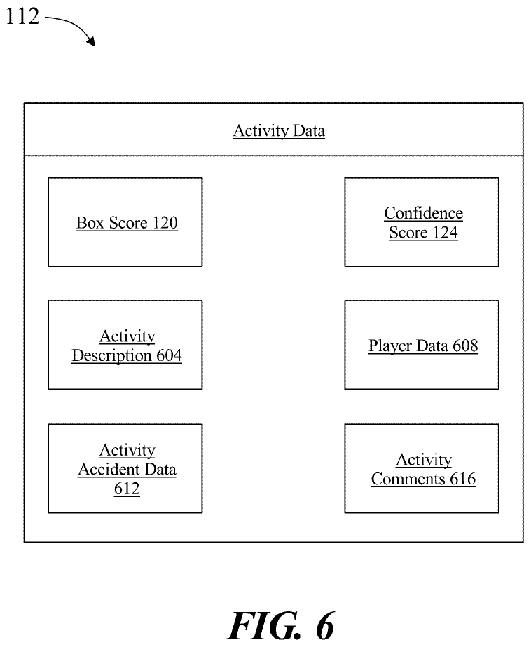

Referring now to FIG. 6, a block diagram of an exemplary embodiment of activity data 112 is illustrated. Activity data 112 may include any activity data described in this disclosure. In some embodiments, without limitation, activity data 112 may include box score 120 described above in this disclosure. In some embodiments, without limitation, activity data 112 may include confidence score 124 described above in this disclosure. In some embodiments, without limitation, activity data 112 may include an activity description 604, wherein the activity description 604 is detailed information related to the activity. In some cases, activity description 604 may include, without limitation, activity rules, an activity schedule, activity history, an activity location, and the like thereof. In a non-limiting example, activity description 604 may specify a location and a time of where activity is took place. In some embodiments, without limitation, activity data 112 may include player data 608, wherein the player data 608 is data related to activity participants (i.e., players). In some cases, player data 608 may include, without limitation, player name, team name, player age, years of playing, accomplishments, player statistics, and the like thereof. In a non-limiting example, player data 608 may include a match history of a player and the player's team along with a win rate. In some embodiments, without limitation, activity data 112 may include an activity accident data 612, wherein the activity accident data 612 is data related to unexpected or unintentional events happened during the activity. In some cases, activity accident data 612 may include, without limitation, weather, injuries, unfortunate incidents and the like. In a non-limiting example, activity accident data 612 may include a reason for an activity cancellation. In some embodiments, without limitation, activity data 112 may include activity comments 616, wherein activity comments 616 is data related to spectators' opinions or reaction to the activity. In some cases, activity comments 616 may include, without limitation, spectators' view, activity explainers' words, online reviews, and the like thereof. In a non-limiting example, activity comments 616 may include a collection of online comments of the activity. Additionally, or alternatively, activity data 112 may be stored in and/or retrieved from activity data source 116 as described above in reference to FIG. 1.

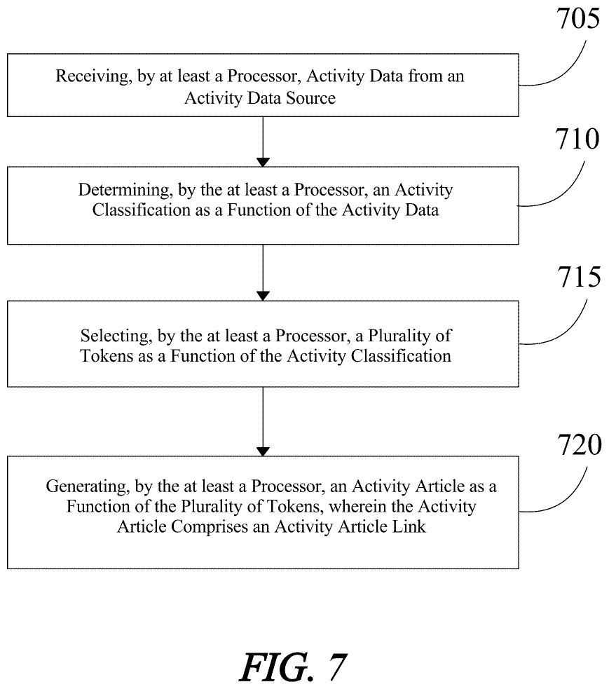

Referring now to FIG. 7, a flow diagram of an exemplary embodiment of a method 700 for generating activity article is illustrated. Method 700 includes a step 705 of receiving, by at least a processor, activity data from activity data source, without limitation, as described above in reference to FIGS. 1-6. In some embodiments, activity data may include a box score. In some embodiments, activity data may include a confidence score. This may be implemented, without limitation, as described above in reference to FIGS. 1-6. In some embodiments, activity data source may include a data store. This may be implemented, without limitation, as described above in reference to FIGS. 1-6.

With continued reference to FIG. 7, method 700 further includes a step 710 of determining, by the at least a processor, an activity classification as a function of the activity data, without limitation, as described above in reference to FIGS. 1-6. In some embodiments, step 710 of determining the activity classification may include applying a plurality of activity conditions. This may be implemented, without limitation, as described above in reference to FIGS. 1-6. In some embodiments, step 710 of determining the activity classification may include training an activity machine-learning process using activity training data, wherein the activity training data may include a plurality of activity data as input correlated to a plurality of activity classification and determining the activity classification as a function of the trained activity machine-learning process. This may be implemented, without limitation, as described above in reference to FIGS. 1-6.

With continued reference to FIG. 7, method 700 further includes a step 715 of selecting, by the at least a processor, a plurality of tokens as a function of the activity classification, without limitation, as described above in reference to FIGS. 1-6. In some embodiments, the plurality of tokens may include a first token corresponds to a first activity classification and a second token corresponds to a second activity classification. This may be implemented, without limitation, as described above in reference to FIGS. 1-6.

With continued reference to FIG. 7, method 700 further includes a step 720 of generating, by the at least a processor, an activity article as a function of the plurality of tokens, wherein the activity article includes an activity article link, without limitation, as described above in reference to FIGS. 1-6. In some embodiments, the activity article may include boilerplate data. In some embodiments, step 720 of generating the activity article may include comparing the confidence score to a confidence threshold and generating the activity article as a function of the comparison of the confidence score and the confidence threshold. This may be implemented, without limitation, as described above in reference to FIGS. 1-6. In some embodiments, step 720 of generating the activity article may include arranging the plurality of tokens as a function of the activity classification. In some embodiments, step 720 of generating the activity article may include exporting the activity article. This may be implemented, without limitation, as described above in reference to FIGS. 1-6. In some embodiments, step 720 of generating the activity article comprises generating the activity article using a language processing module. This may be implemented, without limitation, as described above in reference to FIGS. 1-6. In some embodiments, step 720 of generating the activity article may include generating the activity article link, wherein generating the activity article link may include tagging the activity article with an activity article tag, identifying a previous activity article as a function of the activity article tag, and generating the activity article link as a function of the previous activity article, and inserting the activity article link into the activity article. This may be implemented, without limitation, as described above in reference to FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

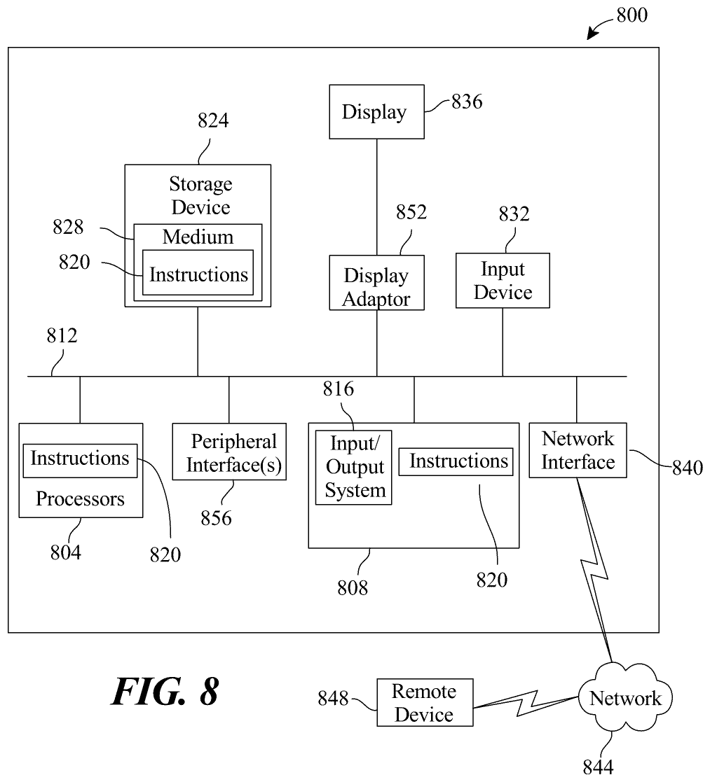

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for generating an activity article, the apparatus comprising:
at least a processor; and
a memory communicatively connected to the at least a processor, wherein the memory contains instructions configuring the at least a processor to:
receive activity data from an activity data source, wherein the activity data further comprises a plurality of confidence scores, and wherein each of the plurality of confidence scores is associated with a box score;
determine a plurality of activity classifications as a function of the activity data, wherein determining the plurality of activity classifications further comprises:
training, iteratively, an activity machine-learning model utilizing activity training data, wherein the activity training data comprises a plurality of activity data as input correlated to the plurality of activity classifications; and
generating an unsupervised machine-learning process after each iteration of the training, wherein the unsupervised machine-learning process is configured to output the plurality of activity classifications;
select a plurality of tokens as a function of the plurality of activity classifications;
generate a first activity article as a function of the plurality of tokens, wherein the first activity article comprises a first file format;
store at least a first collection of activity articles in a database, wherein a previous activity article is selected from the database containing at least one activity article with at least one identical activity article tag;
generate an activity article link as a function of the previous activity article, wherein the activity article link comprises an activity article tag, generating a hyperlink to at least a second activity article with the same activity article tag and inserting the hyperlink into the first activity article; and
export the activity article, wherein exporting the activity article comprises:
converting the activity article from the first file format to a second file format.

2. (canceled)

3. (canceled)

4. The apparatus of claim 1, wherein determining the plurality of activity classifications comprises applying a plurality of activity conditions to the activity data.

5. The apparatus of claim 1, wherein determining the plurality of activity classifications comprises:
training an activity machine-learning process using activity training data, wherein the activity training data comprises a plurality of activity data as input correlated to the plurality of activity classifications; and
determining the activity classifications as a function of the trained activity machine-learning process.

6. The apparatus of claim 1, wherein the plurality of tokens comprises:
a first token corresponding to a first activity classification of the plurality of activity classifications; and
a second token corresponding to a second activity classification of the plurality of activity classifications.

7. The apparatus of claim 1, wherein generating the activity article comprises:
comparing each confidence score to a respective confidence threshold; and
generating the activity article as a function of the comparison of each confidence score and the respective confidence threshold.

8. The apparatus of claim 1, wherein generating the activity article comprises arranging the plurality of tokens as a function of the activity classifications.

9. (canceled)

10. The apparatus of claim 1, wherein generating the activity article comprises:
generating the activity article link, wherein generating the activity article link comprises:
tagging the activity article with an activity article tag;
identifying a previous activity article as a function of the activity article tag; and
inserting the activity article link into the activity article.

11. A method for generating an activity article, the method comprising:
receiving, by at least a processor, activity data from an activity data source, wherein the activity data further comprises a plurality of confidence scores, and wherein each of the plurality of confidence scores is associated with a box score;
determining, by the at least a processor, a plurality of activity classifications as a function of the activity data, wherein determining the plurality of activity classifications further comprises:
training, iteratively, an activity machine-learning model using activity training data, wherein the activity training data comprises a plurality of activity data as input correlated to the plurality of activity classifications; and
generating an unsupervised machine-learning process after each iteration of the training, wherein the unsupervised machine-learning process is configured to output the plurality of activity classifications;
selecting, by the at least a processor, a plurality of tokens as a function of the plurality of activity classifications;
generating, by the at least a processor, a first activity article as a function of the plurality of tokens, wherein the first activity article comprises a first file format;
storing, by the at least a processor, at least a first collection of activity articles in a database, wherein a previous activity article is selected from the database containing at least one activity article with at least one identical activity article tag;
generating, by the at least a processor, an activity article link as a function of the previous activity article, wherein the activity article link comprises an activity article tag, generating a hyperlink to at least a second activity article with the same activity article tag and inserting the hyperlink into the first activity article; and
exporting, by the at least a processor, the activity article, wherein exporting the activity article comprises:
converting the activity article from the first file format to a second file format.

12. (canceled)

13. (canceled)

14. The method of claim 11, wherein determining the plurality of activity classifications comprises applying a plurality of activity conditions to the activity data.

15. The method of claim 11, wherein determining the plurality of activity classifications comprises:
training an activity machine-learning process using activity training data, wherein the activity training data comprises a plurality of activity data as input correlated to the plurality of activity classifications; and
determining the activity classifications as a function of the trained activity machine-learning process.

16. The method of claim 11, wherein the plurality of tokens comprises:
a first token corresponding to a first activity classification of the plurality of activity classifications; and
a second token corresponding to a second activity classification of the plurality of activity classifications.

17. The method of claim 11, wherein generating the activity article comprises:
comparing each confidence score to a respective confidence threshold; and
generating the activity article as a function of the comparison of each confidence score and the respective confidence threshold.

18. The method of claim 11, wherein generating the activity article comprises arranging the plurality of tokens as a function of the activity classifications.

19. (canceled)

20. The method of claim 11, wherein generating the activity article comprises:
generating the activity article link, wherein generating the activity article link comprises:
tagging the activity article with an activity article tag;
identifying a previous activity article as a function of the activity article tag; and
inserting the activity article link into the activity article.
